(19) United States
(12) Patent Application Publication
(10) Pub. No.: US 2001/0055150 A1
(43) Pub. Date: Dec. 27, 2001

(54) Video-type stereoscopic microscope

(76) Inventor: Eiichi Ito, Tokyo (JP)

Correspondence Address: Gerald Levy, Esq., PITNEY, HARDIN, KIPP & SZUCH LLP, 711 Third Avenue, New York, NY, 10017-4059, US

(21) Appl. No.: 09/879,318

(22) Filed: Jun. 12, 2001

(30) Foreign Application Priority Data
Jun. 23, 2000 (JP) 2000-188789

(51) Int. Cl. G02B 21/36

(52) U.S. Cl. 359/363; 359/368

(57) ABSTRACT

A close-up optical system, a pair of an objective optical system, a pair of a relay optical system, an inter-axis distance reducing prism, and a CCD are arranged in a housing, in this order from the front. An opening for allowing the close-up optical system to face the exterior is made in the underside of this housing. A bracket is fixed to an outer edge of the underside of the housing. Fixed at the end of this bracket is a reflecting mirror, which bends the optical axis of the close-up optical system past the opening into a right angle.

### BACKGROUND OF THE INVENTION

1. Field of the Invention

The present invention relates to a video-type stereoscopic microscope for taking a moving picture of a magnified three-dimensional image of an object.

2. Description of the Related Art

This type of video-type stereoscopic microscope is used when tiny tissues, such as a brain, are operated.

Since it is difficult to observe a structure of an organ consisting of tiny tissues, such as a brain, by direct viewing, the operations for such an organ must be proceeded under a microscope. Besides, since it is impossible to observe the three-dimensional structure of a tissue with a monocular microscope, a stereoscopic microscope has been used to enable three-dimensional magnifying observation of the tissue in order to perform accurate operations.

However, with the conventional optical stereoscopic microscope, although a lead surgeon or his/her assistant can observe the microscopic image, other staffs such as anesthetists, nurses, interns, and advisers who work at some remote locations cannot observe the same microscopic image. Therefore, they could not pursue their share of tasks with sufficient accuracy and promptness. Similarly, the adviser could not provide timely and proper advice from the remote locations. Accordingly, in recent years, a video-type stereoscopic microscope, which takes moving pictures of right and left images of an object formed by the stereoscopic microscope to provide the images for three-dimensional observation through a plurality of monitors, has been proposed, instead of an optical stereoscopic microscope. For example, Japanese Patent No. 2607828 discloses a video-type stereoscopic microscope in which right and left images of an object formed by right and left objective optical systems are picked up by a single image pick-up device disposed at the rear of the objective optical systems.

The objective optical system through which the object and the image pick-up device are laid in line causes no problem as long as the patient is shot vertically from above. There arise handling restrictions, however, in shooting complicated parts such as a nasal cavity, which can be shot only from directions where the patient's own body lies. For example, the main body of the video microscope holding the objective optical system and the image pick-up device might come into contact with the patient's body.

### SUMMARY OF THE INVENTION

An object of the present invention is to provide a surgical video microscope of which main body can be surely prevented from contact with the patient's body for better handling.

The surgical video microscope photographs an image of an object formed by an image taking optical system with an image pickup device installed therein. The microscope has a housing holding the image taking optical system and bored with an opening for introducing light from the object into the image taking optical system, and a reflecting mirror supported by the housing to reflect light from a direction which is not parallel with an optical axis of the image taking optical system so that the light is incident on the image taking optical system through the opening of the housing.

By such a configuration, the optical axis of the image taking optical system is bent at the object side thereof by the reflecting mirror. In other words, the direction of the field of view is bent by the reflecting mirror. As a result, the image taking optical system and the image pickup device no longer need to be arranged in line with the object. This prevents the housing from contacting with the patient's body, thereby improving the handling of the video microscope itself.

In this connection, the reflecting mirror may be fixed to the housing as oriented to a predetermined direction, whereas it is desirably supported by the housing so as to be adjustable in the direction of inclination with respect to the optical axis of the image taking optical system. By such a configuration, the housing can be oriented to any direction while the field of view in front of the reflecting mirror is steady. This means a further improvement in handling. The structures to make the reflecting mirror adjustable in the direction of inclination may include a ball joint, a flexible tube, and a universal joint.

### BRIEF DESCRIPTION OF DRAWINGS

The invention will be described below in detail with reference to the accompanying drawing, in which:

FIG. 1 is a schematic view showing an overall construction of a surgical operation support system equipped with a video-type stereoscopic microscope according to a preferred embodiment of the present invention;

FIG. 2 is a schematic view showing an optical construction in the video-type stereoscopic microscope;

FIG. 3 is a schematic view showing an optical construction of a video-type stereoscopic viewer;

FIG. 4 is a plan view of an LCD panel;

FIG. 5 is a perspective view showing an outer appearance of the stereoscopic microscope;

FIG. 6 is a side view showing an overall construction of a microscope optical system;

FIG. 7 is a front view showing an overall construction of the microscope optical system;

FIG. 8 is a plane view showing an overall construction of the microscope optical system;

FIG. 9 is a perspective view showing optical paths inside and outside the housing of the stereoscopic microscope;

FIG. 10 is a diagram showing a usage status of the stereoscopic microscope of a first embodiment;

FIG. 11 is a perspective view showing optical paths inside and outside the housing of the stereoscopic microscope in a second embodiment;

FIG. 12 is a diagram showing a usage status of the stereoscopic microscope of the second embodiment;

FIG. 13 is a perspective view showing optical paths inside and outside the housing of the stereoscopic microscope in a third embodiment; and

FIG. 14 is a perspective view showing a bracket and a reflecting mirror in the stereoscopic microscope of a fourth embodiment.

### DESCRIPTION OF THE PREFERRED EMBODIMENT

The preferred embodiments of the present invention will now be described in detail below with reference to the accompanying drawings.

A video-type stereoscopic microscope (hereafter referred to as “stereoscopic microscope”, for simplicity) according to the present invention is incorporated in a surgical operation supporting system that is used in cerebral surgical operations, for example. In this surgical operation supporting system, the three-dimensional image (stereovision image) of a tissue of a patient, which is taken by a stereoscopic microscope, is combined with CG (Computer Graphic) images, which is created from data about a diseased part in the tissue, in advance. The combined image is displayed on a stereoscopic viewer for a lead surgeon and on monitors for other staffs, and simultaneously recorded by a recording device.

### First Embodiment

The overall configuration of the surgical operation supporting system

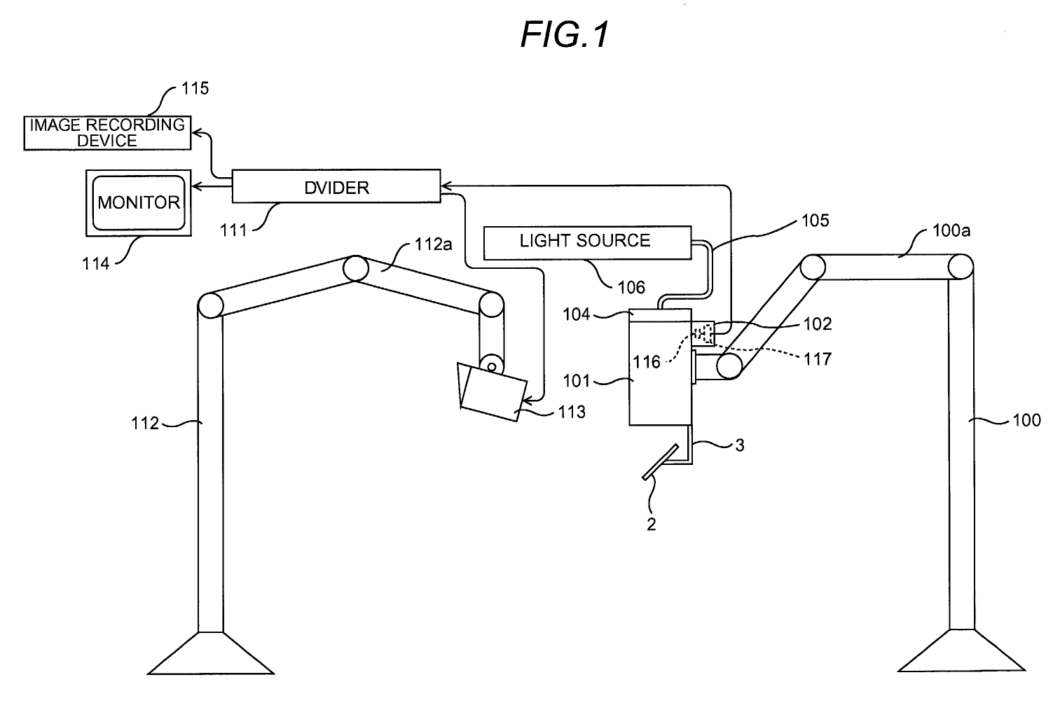

FIG. 1 schematically shows an arrangement of the surgical operation supporting system. As shown in this figure, the surgical operation supporting system is composed of a stereoscopic microscope 101, a high definition CCD camera 102 attached on the upper end of the back surface of the stereoscopic microscope 101, a counter weight 104 attached on the top of the stereoscopic microscope 101, a light guide fiber bundle 105 inserted into the interior of the stereoscopic microscope 101 through a center hole formed in the counter weight 104, a light source 106 emitting illumination light to be introduced into the stereoscopic microscope 101 through the light guide fiber bundle 105, a divider 111 connected to the high definition CCD camera 102, an image recording device 115, a monitor 114 and a stereoscopic viewer 113 which are connected to the divider 111.

The stereoscopic microscope 101 has a mount on its back surface and is detachably fixed to the distal end of a free arm 100a of a first stand 100 through the mount. Thus, the stereoscopic microscope 101 can be moved within the space where the free arm 100a of the first stand 100 can reach, and can also be inclined in an arbitrary direction. Hereinafter, the object side (that is, patient side) relative to the stereoscopic microscope 101 will be defined as “low”, and the opposite side as “high” so that understanding thereof may be easy.

Since the optical configuration in this stereoscopic microscope 101 will be explained in detail later, only its schematics will be explained here.

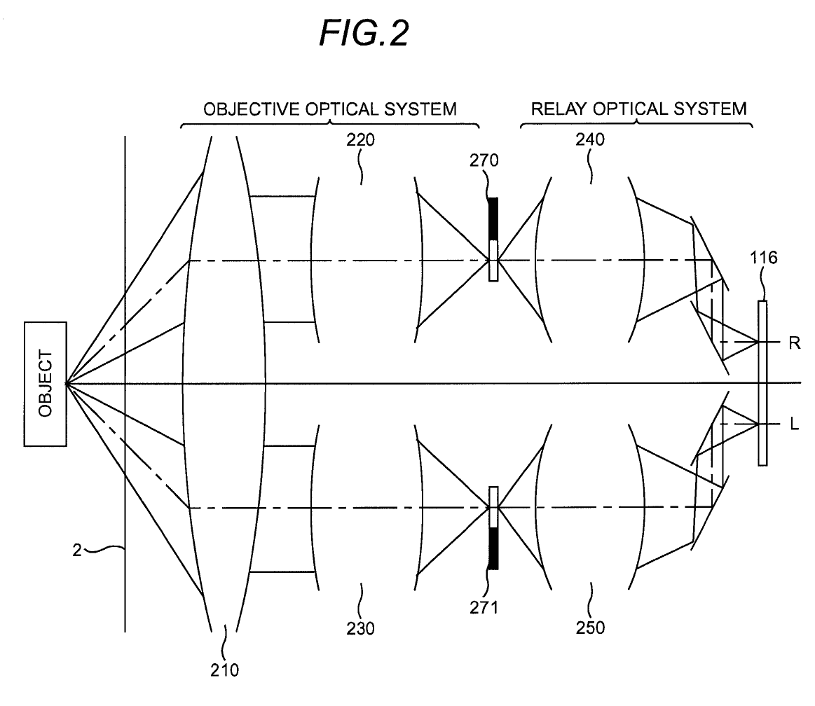

As shown in FIG. 2, primary images of an object are formed as aerial images at respective positions of right and left field stops 270, 271 through an objective optical systems including a large-diameter close-up optical system 210 having a single optical axis and a pair of right and left zoom optical systems 220, 230, which respectively focus light rays that have passed through different portions of the close-up optical system 210. A pair of right and left relay optical systems 240, 250 relay the right and left primary images to form right and left secondary images on the right and left image taking regions in an image taking surface of a CCD 116 mounted in the high definition CCD camera 102, respectively. Each of the image taking regions has a vertical to horizontal aspect ratio of 9:8, while the image taking surface of the CCD 116 has a “high definition” size of which aspect ratio of vertical to horizontal is 9:16.

The close-up optical system 210, the right zoom optical system 220, and the right relay optical system 240 together constitute a right image taking optical system. The close-up optical system 210, the left zoom optical system 230, and the left relay optical system 250 together constitute the left image taking optical system. The close-up optical system 210 is common to the right and left image taking optical systems. The right and left zoom optical systems 220, 230 and the right and left relay optical systems 240, 250 are arranged with a predetermined base length therebetween.

The images which are thus formed on the right and left image taking regions of the image taking surface of the CCD 116 through the pair of image taking optical systems are equivalent to stereovision images including a pair of images taken from two locations which are separated from each other by the predetermined base length, which are arranged side by side. An output signal from this CCD 116 is converted to a high definition video signal by the image processor 117, and is outputted from the high definition CCD camera 102 to the divider 111.

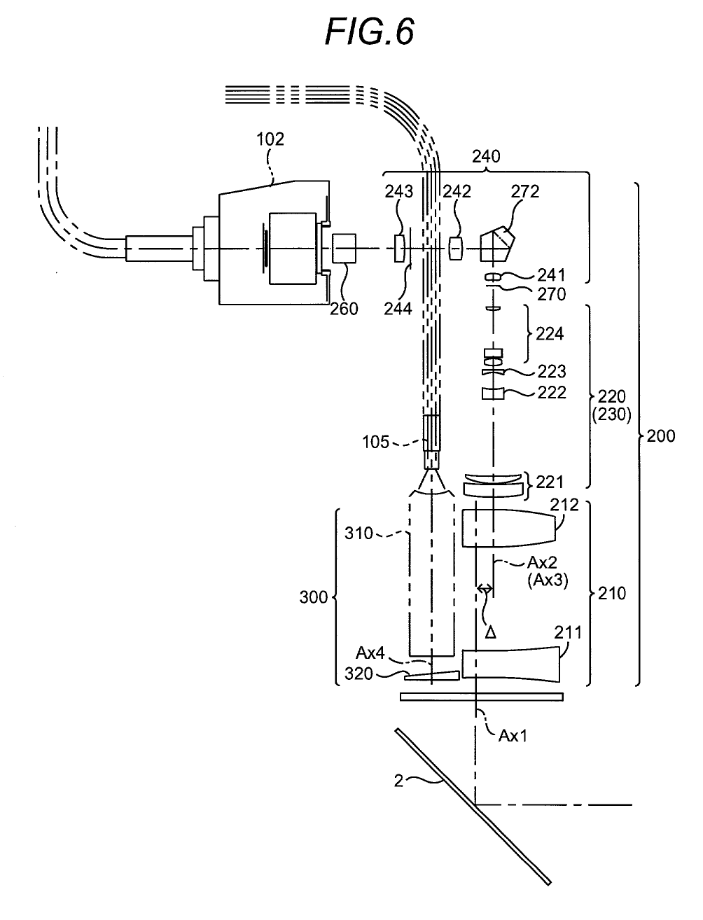

The stereoscopic microscope 101 contains an illuminating optical system 300 (see FIG. 6) for illuminating the object that is located in the vicinity of the focal point of the close-up optical system 210. Illuminating light from the light source 106 is introduced into this illuminating optical system 300 via the light guide fiber bundle 105.

Returning to FIG. 1, the high definition video signal showing the object, which is outputted from the high definition CCD camera 102, is divided by the divider 111, and is supplied to the stereoscopic viewer 113 for a lead surgeon, to the monitor 114 for other surgical staffs or an advisor at a remote location, and to the recording device 115, respectively.

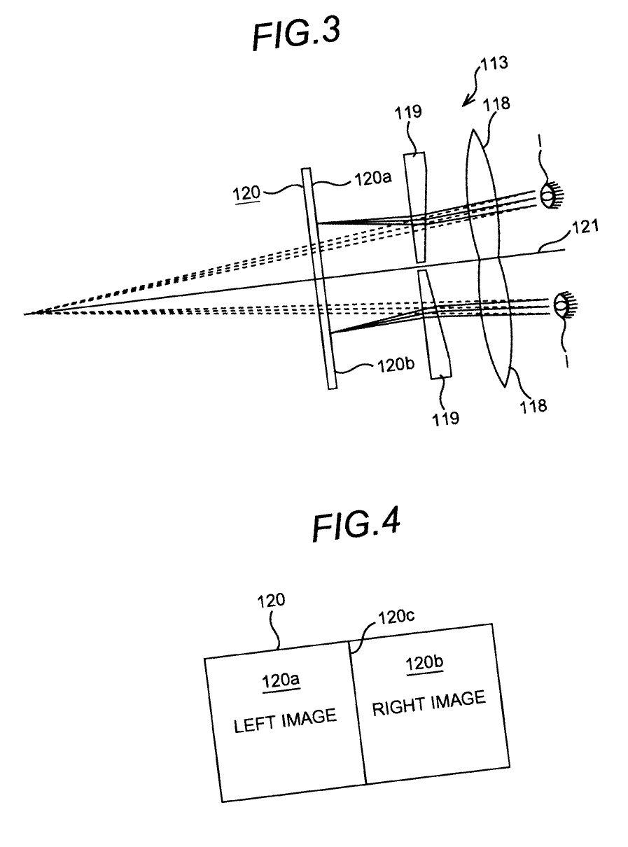

The stereoscopic viewer 113 is attached to the distal end of a free arm 112a of a second stand 112 in the downward direction, so that the stereoscopic viewer 113 can be suitably positioned in accordance with a posture of the lead surgeon that facilitates his/her operations. The schematic structure of this stereoscopic viewer 113 is shown in FIG. 3.

As shown in the FIG. 3, the stereoscopic viewer 113 contains a high-definition-sized LCD panel 120 having an aspect ratio of 9:16 as a monitor. When the high definition video signal from the divider 111 is inputted into the LCD panel 120, as shown in the plan view of FIG. 4, the left half 120a of the LCD panel 120 displays the image taken by the left image taking region of CCD 116, and the right half 120b thereof displays the image taken by the right image taking region of CCD 116.

The light paths in the stereoscopic viewer 113 are divided into the right and the left by a partition 121, which is installed along a direction perpendicular to the LCD panel 120 at the boundary 120c of the left and right halves 120a, 120b of the LCD panel 120. At each side of the partition 121, a wedge prism 119 and an eyepiece 118 are disposed in that order from the side of LCD panel 120. The eyepiece 118 forms a magnified virtual image of the image displayed on the LCD panel 120 at a position that is located 1 m (−1 diopter) in front of observing eyes I. The wedge prism 119 adjusts the direction of the light such that the angle of convergence of the observing eyes I may correspond to that in case of observing an object placed 1 m in front of the eye I naked, thereby enabling natural three-dimensional observation.

The configuration of the stereoscopic microscope

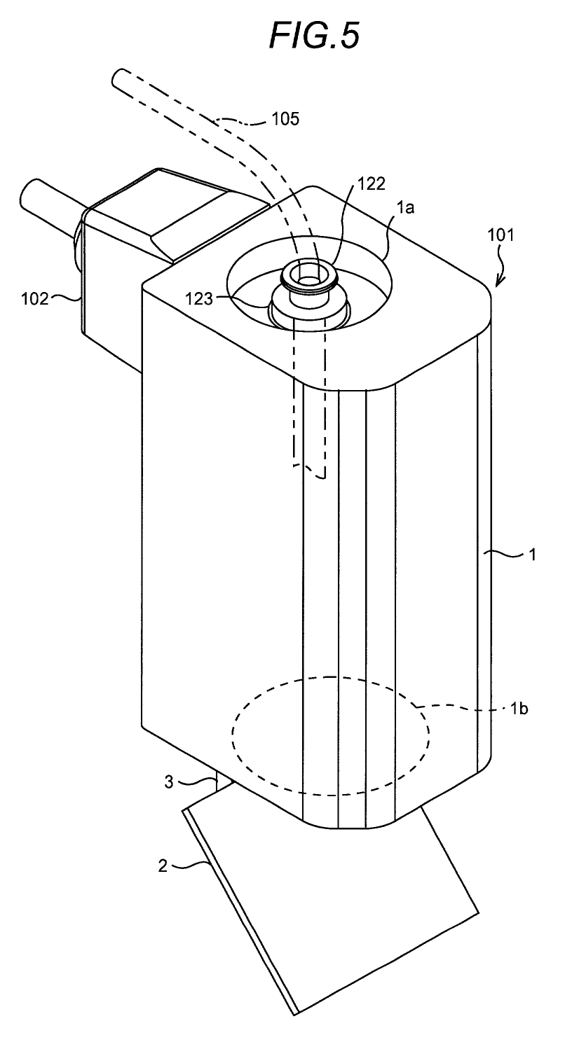

The structure of the above-mentioned stereoscopic microscope 101 (including the high definition CCD camera 102) is explained in more detail. As shown in FIG. 5, this stereoscopic microscope 101 has a shape of substantially polygonal column. The back surface of the stereoscopic microscope 101 is flat and is attached with the high definition CCD camera 102, and the front surface (that is, the opposite side of the back surface) has chamfered edges on both sides.

At the center of the top surface, a circular recess 1a is formed. At the center of the recess 1a, an insertion opening (not illustrated) is bored so as to be inserted with a guide pipe 122, which is a cylindrical member fixedly covering the distal end of the light guide fiber bundle 105. Here, an annular-shaped member (that is, fiber guide insertion part) 123 attached to the insertion opening is a chuck for fixing the guide pipe 122 inserted into the insertion opening.

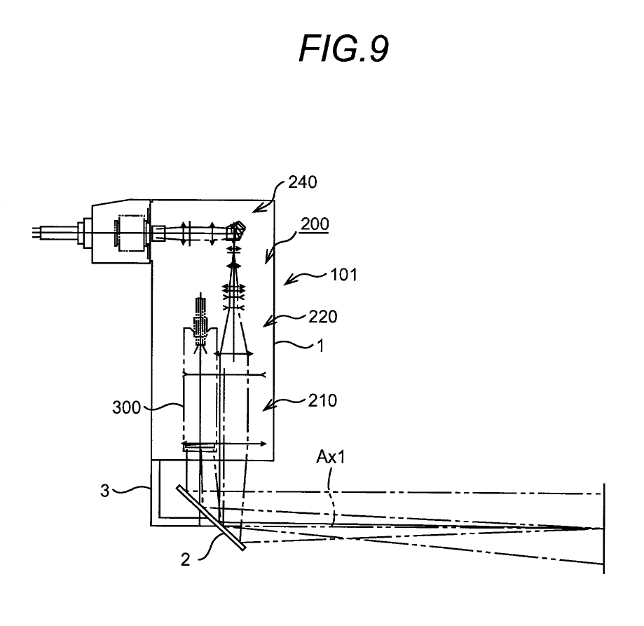

An opening 1b is made in the underside of the housing 1 of the stereoscopic microscope 101. This opening 1b allows the close-up optical system 201 and illuminating optical system 300 described above to face the exterior for light transmission. Besides, as shown in FIG. 9, top end of a bracket 3 consisting of an L-bent square bar is fixed to the underside of this housing 1 near the back surface. A reflecting mirror 2 having a rectangle reflecting surface is fixed to the other end of this bracket 3, so as to incline with respect to the underside of the housing 1 and to face the above-mentioned opening 1b. It follows that the image taking optical system 200 described above forms real images of the object reflected by this reflecting mirror 2. This reflecting mirror 2 may have a circular, elliptic, or any other shape other than rectangular. However, it desirably has a shape to include the coverage of the image taking optical system 100 and that of the illuminating optical system 300.

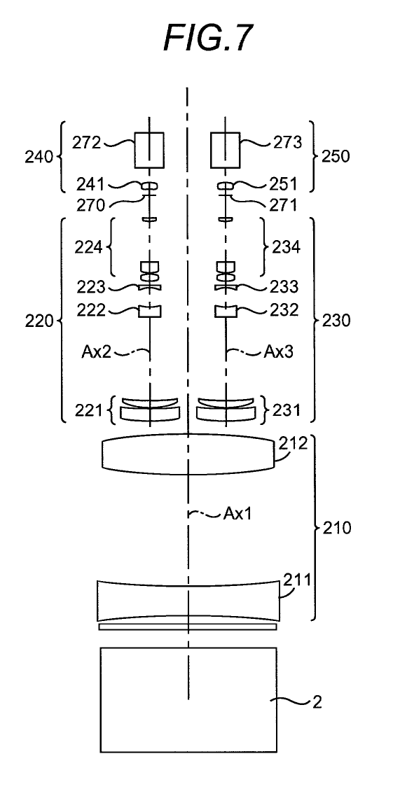

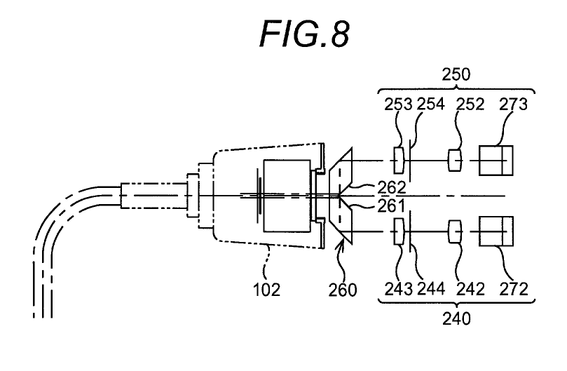

Next, the optical configuration of the stereoscopic microscope 101 will be explained with reference to FIGS. 6 through 8. FIG. 6 is a side view of an overall structure of the microscopic optical system; FIG. 7 is a front view; and FIG. 8 is a plan view of the microscopic optical system.

As shown in FIG. 6, the microscopic optical system includes an image taking optical system (a pair of right and left image taking optical systems) 200 for forming left and right images of an object, an illuminating optical system 300 for illuminating the object with illuminating light guided from the light source 106 through the light guide fiber bundle 105 and the reflecting mirror 2 disposed slantingly in front of the image taking optical system 200 and the illuminating optical system 300.

The image taking optical system 200 includes an objective optical system, which includes a common close-up optical system 210 and a pair of right and left zoom optical systems 220, 230, for forming the primary images of the object; a pair of right and left relay optical systems 240, 250 for forming the secondary images by relaying the primary images; and an inter-axis distance reducing prism 260 as an inter-axis distance reducing element that brings the object light rays from the relay optical systems 240, 250 close to each other. Also, at the positions where the primary images are formed by the zoom optical systems 220, 230, field stops 270, 271 are respectively disposed. In the relay optical systems 240, 250, pentagonal prisms 272, 273 are placed as optical path deflecting elements for deflecting the respective light paths at the right angle. According to this construction, right and left images with a predetermined parallax can be formed on adjacent two regions of the CCD 116 installed in the CCD camera 102. Here, in the following explanations of optical systems, a “horizontal direction” is the direction that coincides with the longitudinal direction of the image taking surface of the CCD 116 when images are projected thereon, and a “vertical direction” is the direction that is perpendicular to the horizontal direction relative to the CCD 116. Each of the optical systems will be explained hereinafter.

As shown in FIGS. 6 and 7, the close-up optical system 210 includes a first lens 211 of a negative refractive power, and a second lens 212 of a positive refractive power arranged in that order from the object side. The second lens 212 moves along its optical axis for focusing in accordance with the object distance. Since the second lens 212 is adjusted so that an object is placed at the object-side focal point of the whole close-up optical system 210, the close-up optical system 210 behaves like a collimator lens to convert divergent light from the object into substantially parallel light. The distance from the vertex of the object-side face of the first lens 211 of the close-up optical system to the object-side focal point of the whole close-up optical system 210 is called “working distance”, which is set to 500+/−100 mm in consideration of focus control region in this embodiment. The plane shape of each of the first and second lenses 211, 212 of the close-up optical system 210, as viewed from the zoom optical systems 220 and 230, is a semicircular shape in which one side is cut out (D-cut). The illuminating optical system 300 is disposed at the cutout portions.

A pair of zoom optical systems 220, 230 focus a focal object light from the close-up optical system 210 at the positions of the field stops 270, 271, respectively. As shown in FIGS. 6 and 7, the right zoom optical system 220 includes first through fourth lens groups 221, 222, 223 and 224 of positive, negative, negative and positive refractive powers, respectively, in that order from the side of the close-up optical system 210. The first and fourth lens groups 221, 224 are fixed, and the second and third lens groups 222, 223 move for zooming along the optical axis direction. The second lens group 222 moves mainly to change the magnification, and the third lens group 223 moves to maintain the focal position. Like the right zoom optical system 220, the left zoom optical system 230 includes the first through fourth lens groups 231, 232, 233, and 234. The right and left zoom optical systems 220, 230 are interlocked by a driving mechanism (not shown in the figures), whereby the magnifications of the right and left images can be changed simultaneously.

The optical axes Ax2, Ax3 of the zoom optical systems 220, 230 are in parallel with the optical axis Ax1 of the close-up optical system 210. A first plane that includes these optical axes Ax2, Ax3 of the zoom optical systems 220, 230 is offset from a second plane, which is parallel to the first plane and includes the optical axis of the close-up optical system 210, by a distance A at the opposite side of the D-cut portion. The diameter of the close-up optical system 210 is set to be larger than the diameter of a circle that includes the maximum effective diameters of the zoom optical systems 220, 230 and the maximum effective diameter of the illuminating optical system 300. As described above, since the optical axes Ax2, Ax3 of the zoom optical systems 220, 230 are positioned oppositely to the D-cut portion with respect to the optical axis Ax1, the illuminating optical system 300 can be placed inside of a circular region defined by the diameter of the outline shape.

The field stops 270, 271 are disposed at the position where the primary images are formed by the zoom optical systems 220, 230. Each of the field stops 270, 271 has a semi-circular aperture which is concentric with the outer circular edge of the field stop 270, 271 and which is formed at a portion adjacent to the other field stop 271, 270. The straight edges of these apertures coincide with the vertical direction corresponding to the boarder line of the right and left images on the CCD 116. Only flux traveling inside of each of the straight edges can be transmitted.

The microscope according to the present embodiment needs to avoid overlapping of the right and left images on the CCD 116 in order to form the right and left secondary images on adjacent regions of the single CCD 116. Therefore, the field stops 270, 271 are placed at the position of the respective primary images. The straight edge of the semi-circular shaped aperture of each of those field stops 270, 271 functions as a knife-edge, so that only light rays traveling inside the edge can pass through the field stop 270, 271. The primary images formed on the field stops 270, 271 are re-imaged through the right and left relay optical systems 240, 250 as secondary images. The resultant secondary images are reversed in the horizontal direction and in the vertical direction with respect to the primary images. Thus, the knife edges defining the outside edges in the horizontal direction at the positions of the primary images define the inside edges in the horizontal directions at the positions of the secondary images, which clearly defines the boundary of the right and left images.

The relay optical systems 240, 250 includes three lens groups of positive refractive powers, respectively. As shown in FIGS. 6 and 7, the right relay optical system 240 includes a first lens group 241 composed of a single positive meniscus lens, a second lens group 242 having a positive refractive power as a whole, and a third lens group 243 composed of a single biconvex lens. The object side focal point of the combination of the first and second lens groups 241 and 242 is coincident with the image forming plane of the primary image formed by the zoom optical system 220. That is the same position as the field stop 271. The third lens group 243 converges parallel light transmitted from the second lens group 242 onto the image taking surface of the CCD 116. Between the first lens group 241 and the second lens group 242, the pentagonal prism 272 is disposed for deflecting the light path at the right angle. Between the second lens group 242 and the third lens group 243, an aperture stop 244 is installed for adjusting the light amount. Like the right relay optical system 240, the left relay optical system 250 includes the first, second and third lens groups 251, 252 and 253. The pentagonal prism 273 is disposed between the first lens group 251 and the second lens group 252, and an aperture stop 254 is installed between the second lens group 252 and the third lens group 253. The divergent light that has passed through the field stops 270, 271 is converted to substantially parallel light through the first lens groups 241, 251 and the second lens groups 242, 252 of the relay optical systems. After passing through the aperture stops 244, 254, the light rays are re-converged through the third lens groups 243, 253 to form the secondary images. Since the pentagonal prisms 272, 273 are disposed inside the relay optical systems 240, 250, the total length of the image taking optical system 200 along the optical axis Ax1 of the close-up optical system 210 can be shortened.

The inter-axis distance reducing prism 260 is disposed between the relay optical systems 240, 250 and the CCD camera 102 to reduce the distance between the right and left object light rays from the respective relay optical systems 240, 250. To attain real stereoscopic feeling by the stereoscopic observation, it is necessary to have a predetermined base length between the right and left zoom optical systems 220, 230 and between the right and left relay optical systems 240, 250. On the other hand, to form secondary images on the adjacent regions on the CCD 116, it is necessary to shorten the distance between the optical axes than the base length. The inter-axis distance reducing prism 260 brings the optical axes of the relay optical systems close to each other, which enables to form secondary images on the same CCD 116 while keeping the predetermined base length. As shown in FIG. 8, the inter-axis distance reducing prism 260 includes a pair of optical axis shifting prisms 261, 262 having shapes of the pentagonal columns, which are symmetric to each other. The prisms 261, 262 are arranged in a right and left symmetric configuration with a spacing of about 0.1 mm therebetween.

As shown in FIG. 8, each of the optical axis shifting prisms 261, 262 has incident and exit surfaces that are parallel to each other, and has first and second reflecting surfaces in the respective outer side and inner side, which are also parallel to each other. Viewed in the direction parallel to the incident and exit surfaces and reflecting surfaces, these optical axis shifting prisms 261, 262 have a pentagonal shape formed by cutting out an acute-angle corner of a parallelogram with a line perpendicular to the exit surface.

The object lights from the relay optical systems 240, 250 are incident on the incident surfaces of the respective optical axis shifting prisms 261, 262; internally reflected by the outer reflecting surfaces so as to be directed in the horizontal direction; internally reflected by the inner reflecting surfaces so as to be directed to the optical axis directions that are the same as the incident direction; and are exited from the exit surfaces so as to be incident on the CCD camera 102. As a result, the distance between the right and left object light rays is narrowed without altering the traveling directions, and the secondary images are formed on the single CCD 116.

The illuminating optical system 300 has the function of projecting illumination light onto the object, and, as shown in FIG. 6 includes an illuminating lens 310 for adjusting the degree of divergence of divergent light emitted from the light guide fiber bundle 105 and a wedge prism 320 for deflecting the illumination light to coincide the illuminating region with the image taking region. As shown in FIG. 6, the optical axis Ax4 of the illuminating lens 310 is parallel to the optical axis Ax1 of the close-up optical system 210, and is offset from the optical axis Ax1 by a predetermined amount. Therefore, if the wedge prism 320 is not disposed, the center of the illuminating region would not coincide with the center of the image taking region, which wastes some amount of illuminating light. The wedge prism 320 matches the illuminating region with the image taking region, which enables effective use of the illuminating light.

The reflecting mirror 2 is composed of a plate glass having the rectangular reflecting surface and a protective plate pasted on the back of this plate glass. This reflecting mirror is set so that either one pair of its outer edges may be parallel to an axis orthogonal to both the optical axes Ax2 and Ax3 of the zoom optical systems 220 and 230, and that its reflecting surface may incline 450 with respect to the optical axis Ax1 of the close-up optical system 210. Accordingly, the optical axis Ax1 of the close-up optical system 210 is bent forward at a right angle by this reflecting mirror 2. As shown in FIG. 9, an object lying on the object plane in front of the bent optical axis Ax1 (at the position away from the close-up optical system 210 along the optical axis Ax1 by the working distance) is irradiated with the illumination light from the illuminating optical system 300. The image of this object is then formed on the CCD 116 by the image taking optical system 200.

Usage of the Stereoscopic Microscope

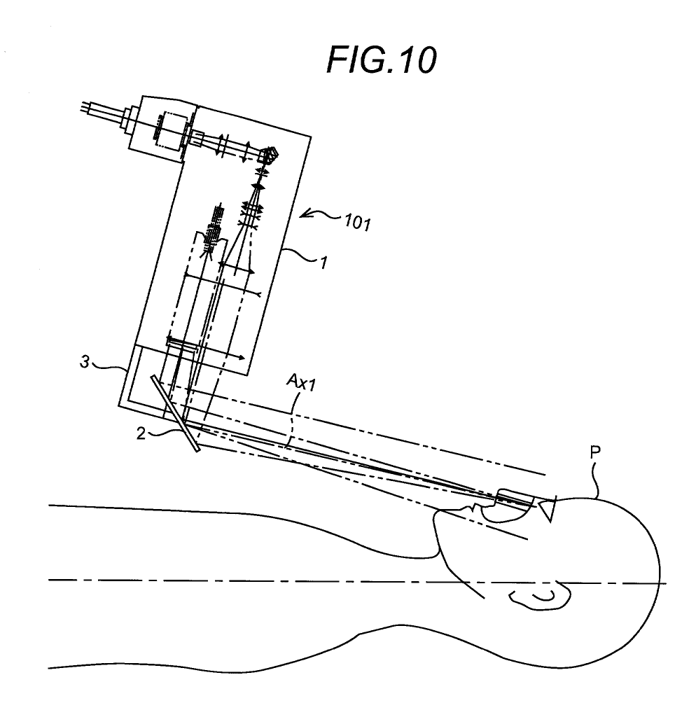

Next, description will be given of how to use the stereoscopic microscope 101 of the present embodiment having the configuration described above. The stereoscopic microscope 101 of the present embodiment can be used to shoot a patient from a position unobstructive to the operation (above or beside the patient). In addition, as shown in FIG. 10, the stereoscopic microscope 101 can shoot even the interior of the patient's nasal cavity without coming into contact with the body of the patient. Using a conventional video microscope, the object (interior of the nasal cavity) and the shooting optical system are laid into line with each other so that the housing containing the image taking optical system might come into contact with the topside (i.e., chest or abdomen) of the patient's body. With the stereoscopic microscope 101 of the present embodiment, the optical axis Ax1 from the object to the image taking optical system is bent at a right angle by the reflecting mirror 2, whereby the housing 1 of the stereoscopic microscope 101 is prevented from contact with the body of the patient P. Indeed, in some cases, the reflecting mirror 2 itself can possibly come into contact with the body of the patient P, this reflecting mirror 2, however, has an area only slightly greater than those of the optical paths of the illumination light and the object light. Therefore, the possibility of this reflecting mirror 2 coming into contact with the patient's body is significantly smaller than that of the conventional housing coming into contact with the patient's body.

In the present embodiment, the bracket 3 may be configured detachable from the housing 1, which enhances the stereoscopic microscope 101 in posture flexibility for situations where it is placed above or beside a patient.

### Second Embodiment

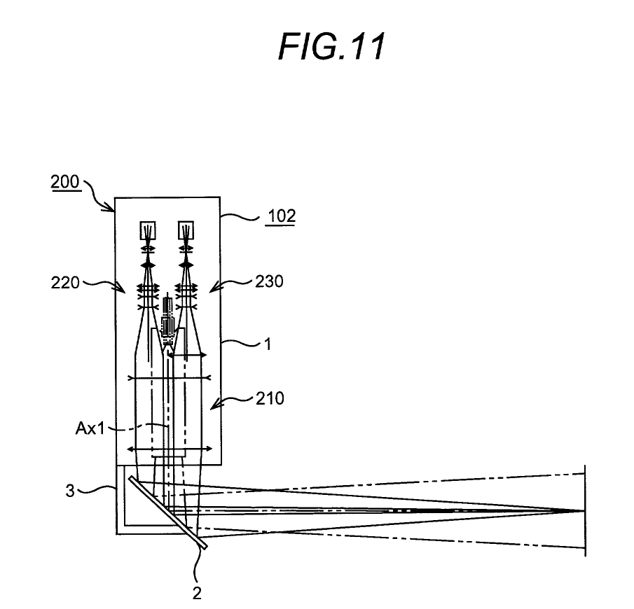

A stereoscopic microscope 102 according to a second embodiment of the present invention differs from the stereoscopic microscope 101 of the first embodiment described above only in the following two points: that is, the mounting position of the bracket 3 on the underside of the housing 1, and the direction of inclination of the reflecting mirror 2 with respect to the image taking optical system 200 and the illuminating optical system 300. Specifically, with reference to the mounting position of the bracket 3 in the first embodiment, the bracket 3 of the stereoscopic microscope 102 in the second embodiment is mounted on a position shifted 900 about the optical axis Ax1 of the close-up optical system 210, counterclockwise as seen from the close-up optical system 210. The direction of inclination of the reflecting mirror 2 with respect to this bracket 3 is identical to that of the first embodiment. Therefore, as shown in FIG. 11, this reflecting mirror 2 is set so that either one pair of its outer edges may be parallel to an axis orthogonal to both the optical axis Ax1 of the close-up optical system 210 and the optical axis Ax4 of the illuminating lens 310, and that its reflecting surface may incline 45° with respect to the axis Ax1 of the close-up optical system 210. Accordingly, the optical axis Ax1 of the close-up optical system 210 is bent sideways at a right angle by this reflecting mirror 2. As shown in FIG. 11, an object lying on the object plane in front of the bent optical axis Ax1 (at the position a working distance away from the close-up optical system 210 along the optical axis Ax1) is irradiated with the illumination light from the illuminating optical system 300. The image of this object is then formed on the CCD 116 by the image taking optical system 200.

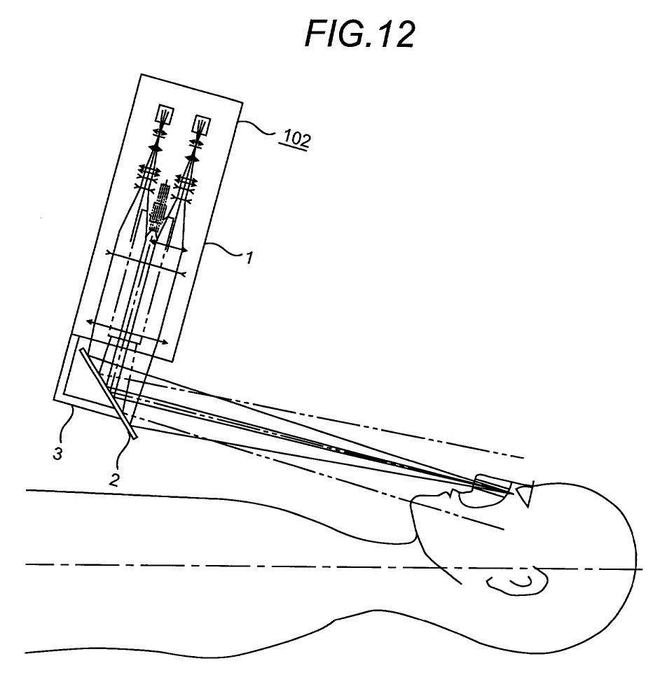

FIG. 12 is a diagram showing the stereoscopic microscope 102 of the present embodiment in use. As shown in this FIG. 12, the stereoscopic microscope 102 of the present embodiment can be used just as in the case of the stereoscopic microscope 101 of the first embodiment.

In this embodiment, the bracket 3 may also be configured detachable from the housing 1. In this case, the bracket 3 and the reflecting mirror 2 to be detached are structurally identical to those of the first embodiment. Therefore, if its housing 1 is provided with mounts at positions corresponding to both the first and second embodiments, the single stereoscopic microscope 102 corresponds both of the first and second embodiments. This means a further improvement in the handling of the stereoscopic microscope 102.

Since the other configuration and function of this second embodiment are identical to those of the foregoing first embodiment, description thereof will be omitted here.

### Third Embodiment

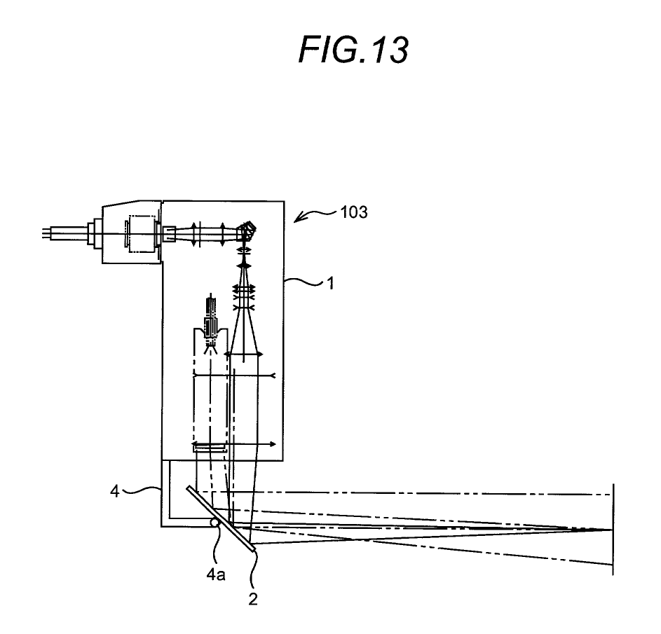

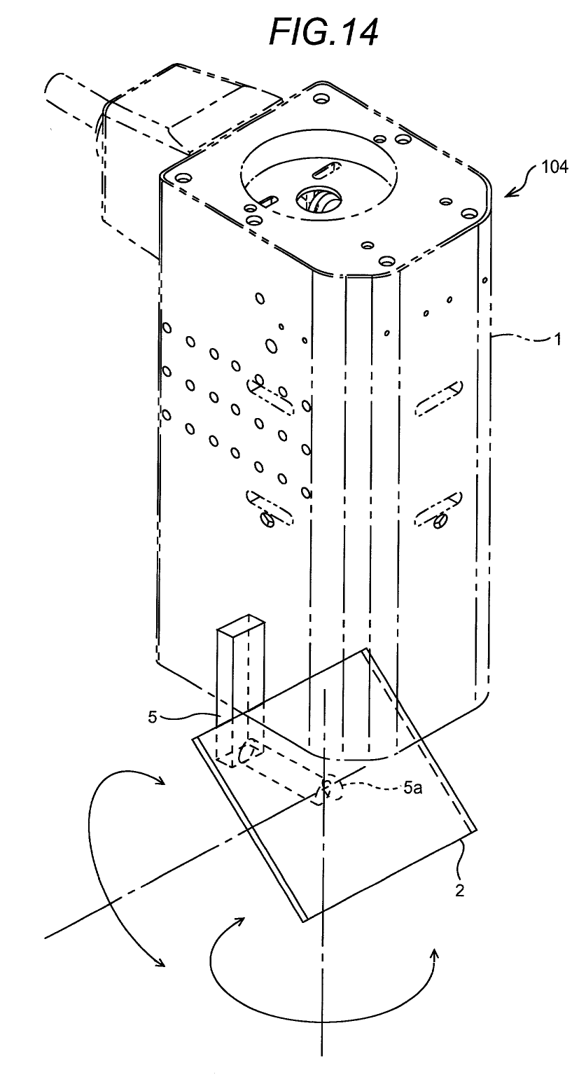

A stereoscopic microscope 103 according to a third embodiment of the present invention differs from the stereoscopic microscope 101 of the first embodiment described above only in the structure of the connection between the end of a bracket 4 and the reflecting mirror 2. Specifically, as shown in FIG. 13, the end of the bracket 4 in the stereoscopic microscope 103 of the third embodiment rotatably supports, under predetermined friction, a rotating shaft 4a which is fixed to the center of the back surface of the reflecting mirror 2. Here, the rotating shaft 4a is oriented parallel to an axis orthogonal to the axes Ax2 and Ax3 of both the zoom optical systems 220 and 230.

According to the present embodiment, the angle of inclination of the reflecting mirror 2 can be adjusted arbitrarily to change the direction of the optical axis Ax1 of the close-up optical system 210 deflected by the reflecting mirror 2 freely. Therefore, even in the cases where the optical axis Ax1 in front of the reflecting mirror 2 must be oriented to a fixed direction, the angle of the housing 1 can be changed freely. This means a further improvement in the handling of the stereoscopic microscope 103.

Since the other configuration and function of this third embodiment are identical to those of the foregoing first embodiment, description thereof will be omitted here.

Fourth Embodiment

A stereoscopic microscope 104 according to a third embodiment of the present invention differs from the stereoscopic microscope 101 of the first embodiment described above only in the structure of the connection between the end of a bracket 5 and the reflecting mirror 2. Specifically, the end of the bracket 5 in the stereoscopic microscope 104 of the fourth embodiment is attached to the center of the back surface of the reflecting mirror 2 via a ball joint 5a. This makes the reflecting mirror 2 tiltable to a certain extent of angles in any direction, with reference to the position of the reflecting mirror 2 of the first embodiment. Therefore, even when compared to the third embodiment described above, the stereoscopic microscope 104 further improves in handling.

As has been described, according to the surgical video microscope of the present invention, the contact of the main body with the patient's body can be prevented for better handling.

We claim:

1. A surgical video microscope for picking up an image of an object formed by an image taking optical system with an image pickup device, the microscope comprising:
a housing holding said image taking optical system, and bored with an opening for introducing light from said object into said image taking optical system; and
a reflecting mirror supported by said housing, for reflecting light from a direction which is not parallel with an optical axis of said image taking optical system so that the light is incident on said image taking optical system through said opening of said housing.

2. The surgical video microscope according to claim 1, wherein:
a pair of image taking optical systems are provided and said reflecting mirror simultaneously reflects light incident on said pair of image taking optical systems.

3. The surgical video microscope according to claim 1, wherein
said reflecting mirror is supported by said housing so as to be adjustable in the direction of inclination with respect to the optical axis of said image taking optical system.

4. The surgical video microscope according to claim 1, wherein
said reflecting mirror is attached to an end of a bracket fixed to said housing.

5. The surgical video microscope according to claim 3, wherein
said reflecting mirror is attached to an end of a bracket via a hinge, said bracket being fixed to said housing.

6. The surgical video microscope according to claim 3, wherein
said reflecting mirror is attached to an end of a bracket via a ball joint, said bracket being fixed to said housing.

7. The surgical video microscope according to claim 1, wherein
the optical axis of said image taking optical system is bent in the housing.

8. The surgical video microscope according to claim 1, further comprising an illuminating optical system for emitting illumination light, and wherein
said reflecting mirror reflects the illumination light emitted from said illuminating optical system.
